(19) United States
(12) Patent Application Publication
(10) Pub. No.: US 2015/0042142 A1
(43) Pub. Date: Feb. 12, 2015

(54) DEVICE FOR FIXING A HEADREST TO A VEHICLE SEAT AND VEHICLE SEAT HAVING A HEADREST

(71) Applicants: Joshua Hesterberg, Mettmann (DE); Ladislav Gurbal, Kosice (SK)

(72) Inventors: Joshua Hesterberg, Mettmann (DE); Ladislav Gurbal, Kosice (SK)

(73) Assignee: Johnson Controls GmbH

(21) Appl. No.: 14/116,535

(22) PCT Filed: May 7, 2012
(86) PCT No.: PCT/EP2012/001955

§ 371 Date: Jan. 19, 2014

(30) Foreign Application Priority Data
May 9, 2011 (DE) 10 2011 100 955.1
Sep. 3, 2011 (DE) 10 2011 112 418.0

(51) Int. Cl. B60N 2/48

(52) U.S. Cl. CPC B60N 2/4805
USPC 297/391

(57) ABSTRACT

A device is provided for securing a head restraint to a seat of a vehicle, the head restraint having at least one, typically two, mounting rods which are pushed into associated receiving sleeves, the receiving sleeves being secured to the vehicle seat by connecting elements and the receiving sleeve having a connecting section which is connected, in particular welded, to the connecting element. The connecting section of the receiving sleeve and the connecting element are configured, in the area in which the connecting element is contacted by the connecting section, in such a way that, in the event of a displacement of the connecting element along the connecting section, the angle of the connecting element with respect to the receiving sleeve changes. As a result, a particularly flexibly usable device for securing a head restraint to a vehicle seat is provided.

The invention relates to a device for fixing a headrest to a seat of a vehicle, in particular of a motor vehicle, wherein the headrest has at least one, typically two retaining rods, which are pushed into associated receiving sleeves, wherein the receiving sleeves are fixed to the vehicle seat with connecting elements. The receiving sleeve has a connecting section, which is connected, in particular welded, to the connecting element. The connecting element(s) are then fixed to the vehicle seat, in particular welded there. The invention furthermore relates to a vehicle seat having a device for fixing a headrest to a seat of a vehicle.

A head rest for a vehicle seat and a vehicle seat are known for example from DE 10 2008 055 987 A1. The crash-active headrest described here has adjustment means, with which the headrest can be changed in position in the event of an impact. DE 10 2004 013 979 B3 discloses a device for retaining a headrest on a vehicle seat, which device has a tolerance compensation means, which can be laterally displaced with respect to the retaining device.

The invention is based on the object of creating a device, which can be used particularly flexibly, for fixing a headrest to a seat of a vehicle.

The object is achieved according to the invention in that the connecting section of the receiving sleeve and the connecting element in the region in which the connecting section makes contact with it are designed in such a manner that when the connecting element is displaced along the connecting section the angle of the connecting element with respect to the receiving sleeve changes. A basic design can thereby be used for a multiplicity of different seat applications, in which the angle between the retaining rods of the headrest and the seat structure can be set.

“Can be set” in this case means that the connecting section of the receiving sleeve can be placed in different positions or at different angles with respect to the connecting element. When the connecting section is connected to the connecting element, an angle is then defined at which the receiving sleeves are arranged with respect to the connecting elements and thus the retaining rods of the headrest are arranged with respect to the seat structure. The retaining rods and receiving sleeves have a longitudinal axis which is arranged essentially vertically. The final definition of the angle takes place preferably by welding and cannot be changed subsequently. The possibility of simply adapting the angle of the retaining rods of the headrests in relation to the seat structure makes it possible to use the parts according to the invention in different seat structures, as a result of which a high saving potential for tools and logistics is achieved.

To this end, the connecting section is in particular curved, ellipsoid, cylindrical or convex. The connecting section moulded onto the receiving sleeve therefore has a contact face for the connecting element, which preferably runs approximately parallel to the longitudinal axis of the receiving sleeve and according to the invention does not have a flat face but an outwardly curved or convex shape, by means of which a variation in angle is made possible.

The connecting section is preferably essentially rectangular in its basic shape, longitudinal and transverse sides of the rectangular connecting section delimiting its contact face. The longitudinal side runs parallel to the longitudinal axis of the receiving sleeve and is approximately 2 times to 4 times, preferably 2.5 times to 3.5 times as long as the transverse side of the connecting section which runs perpendicularly to the longitudinal axis of the receiving sleeve. According to the invention, the connecting section is rounded and expands by approximately 10% to 40%, preferably by approximately 15% to 25%, compared to the transverse sides formed as end sides. A face perpendicular running on the contact face thus changes constantly if different points in the vertical extent of the connecting section are viewed from the side.

The connecting section exits from the receiving sleeve in the process and ends laterally to the contact face in flat side regions, which have an outwardly curved rounded portion in the form of a part-circle or part-ellipse corresponding to the contact face formed on the connecting section. The connecting section or its contact face is furthermore symmetrical with respect to at least one central line in the vertical and/or horizontal extent.

Accordingly, the counterpiece of the connecting section, the connecting element to a vehicle seat, has the same or a corresponding shape. Displaceability, in particular angular displaceability of the receiving sleeves with respect to the vehicle seat is achieved by a corresponding rounded portion on the connecting element, in particular a recess formed inwardly or towards the vehicle seat. The connecting element, which is connected to the receiving sleeve or the connecting section of the receiving sleeve on one side and to the seat structure on the other side, is also referred to as a retaining bracket. Connection preferably takes place in each case by means of welded connections.

This connecting element, referred to as a retaining bracket, has a wide central contact region, on which the connection to the receiving sleeve or to the connecting section of the receiving sleeve takes place. Proceeding from there, there are in each case approximately 90° bends and then another two approximately 90° bends, so that two outer regions are created, which are also referred to as wings. The wings are arranged in a plane approximately parallel to the plane of the central contact region and are used for connection to the seat structure. According to the invention, the contact region of the connecting element is curved, in particular concave, and corresponds to the curvature of the connecting section of the receiving sleeve. With a corresponding, concave curvature, displaceability of the connecting element with respect to the receiving sleeve is possible, in particular vertically in the “up and down” direction, so that the alignment of the receiving sleeve changes owing to the curved, in particular concave shape. At the same time, however, the greatest possible areal contact between the connecting section of the receiving sleeve and the central face of the connecting element is retained.

The connecting section on the receiving sleeve is preferably convex, whereas the corresponding rounded portion on the connecting element is concave. A precisely reversed configuration is however also conceivable, that is, that the connecting section of the receiving sleeve is concave whereas the connecting element then has a corresponding convex shape.

In another preferred configuration of the invention, the connecting element is shorter in its vertical extent than the connecting section on the receiving sleeve, so that displaceability upwards and downwards is possible, but at the same time the connecting element is in contact over its entire area.

The invention also relates to a vehicle seat for a vehicle, in particular a motor vehicle, which has a device for fixing a headrest, as described, having a receiving sleeve and a connecting element which are to be arranged at different angles to each other.

The invention is explained in more detail below using a preferred exemplary embodiment shown in the drawing. In the figures:

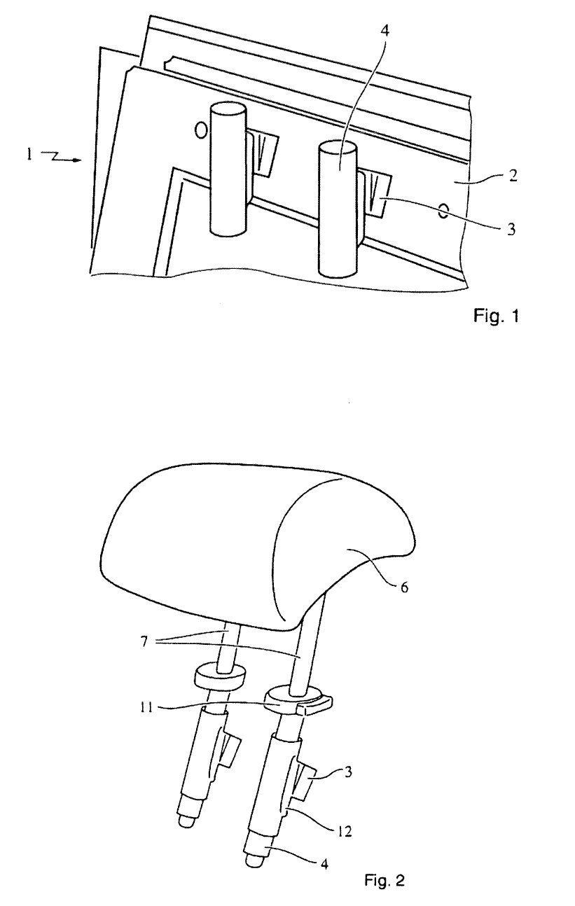

FIG. 1: shows a detail of a vehicle seat having a device for fixing a headrest according to the prior art in a perspective view;

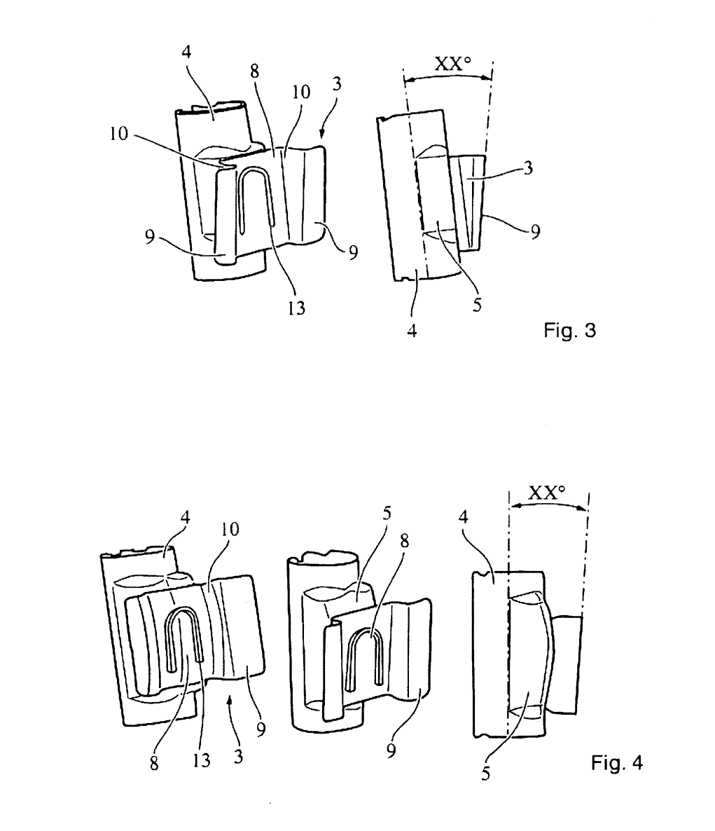

FIG. 2: shows a headrest having a device for fixing the same according to the prior art in a perspective view;

FIG. 3: shows a two-part fixing means for a headrest according to FIG. 1 in two views;

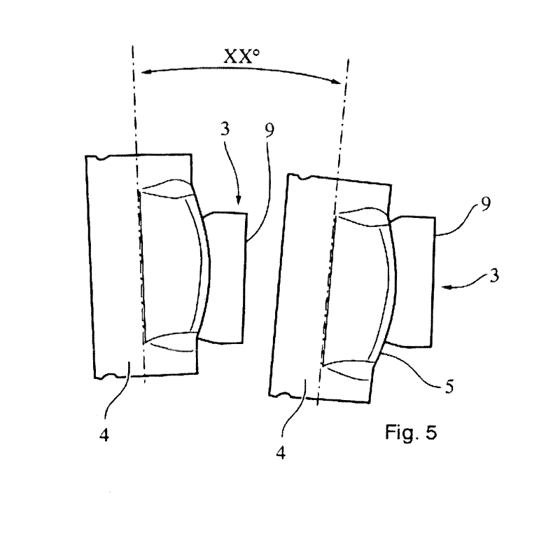

FIG. 4: shows a device according to the invention for fixing a headrest in three different views; and

FIG. 5: shows a diagram of the device according to the invention of FIG. 4, wherein the connecting section and the connecting element are arranged at different angles to each other.

FIG. 1 shows a detail of a vehicle seat 1 having a seat structure 2 which is integrated mechanically in the said vehicle seat 1. Connecting elements 3, which are also referred to as retaining brackets, are fixed, in particular welded, to this mechanically stable seat structure 2. Receiving sleeves 4 are arranged, in particular welded by means of connecting sections provided on the receiving sleeves 4, on the said connecting elements 3.

FIG. 2 shows a headrest 6 having retaining rods 7 according to the prior art. In this specific configuration, the retaining rods 7 are accommodated in receiving sleeves 4 having a covering ring 11 arranged in one piece thereon. The connecting element 3 is formed in one piece with an outer sleeve 12, which is pushed over the receiving sleeve 4 and thus connects the connecting element 3 to the receiving sleeve 4.

FIG. 3 shows a detail of a receiving sleeve 4 having a connecting section 5 and a connecting element 3 fixed thereto according to the prior art, which differs from the prior art shown in FIG. 2. The connecting section 5 is essentially rectangular and forms a flat contact face for the connecting element 3. The connecting section 5 of the receiving sleeve 4 is aligned essentially parallel to a longitudinal axis of the receiving sleeve 4. The connecting element 3, which is also referred to as a retaining bracket, has, in addition to a central contact region 8, which is connected to the receiving sleeve 4, two outer wings 9, which are arranged in one plane and are used for connection to the seat structure by means of laser welding, and two transition regions 10, which connect the central contact region 8 to the outer wings 9. A U-shaped or horseshoe-shaped welded connection produced by laser welding is shown in the flat contact region and labelled with the reference symbol 13. When the connecting element 3 is mounted on the receiving sleeve 4, the receiving sleeve 4 or its longitudinal axis and the plane in which the wings 9 of the connecting element 3 are arranged form a defined angle, which is labelled “XX°” in FIG. 3.

FIG. 4 shows the receiving sleeve 4 according to the invention with the connecting element 3 according to the invention. It can be seen that the connecting section 5 and the receiving element 3, in particular its central contact region 8, have curved sections which correspond to each other, so that they bear against each other over their areas. This areal contact is retained even if the connecting element 3 is displaced in the vertical direction, upwards or downwards along the connecting section 5 of the receiving sleeve 4. In the position shown, that is, with the connecting element 3 arranged comparatively low down on the connecting section 5, a certain angle “XX°” is produced in this case too between the longitudinal axis of the receiving sleeve 4 and the connecting element 3 or the wings 9 of the connecting element 3. It can also be seen here that the vertical extent of the connecting element 3 is smaller than that of the connecting section 5. This makes possible a displacement of the two sections corresponding to each other upwards and downwards, in particular the connecting element 3 can be displaced along the connecting section 5 and is always in contact over its entire area, so that a weld seam 13, in particular produced by laser welding, can be produced on this section.

FIG. 5 shows the positioning of the connecting element 3 according to the invention with two examples at two different points on the receiving sleeve 4 according to the invention. In the example shown on the left, the connecting element 3 is arranged as far down as possible, whereas in the example shown on the right, the connecting element 3 is arranged as far up as possible on the connecting section 5 of the receiving sleeve 4. The angle of the receiving sleeve 4 is thereby changed with respect to the seat structure while the alignment of the receiving element 3, in particular of the wings 9 on the seat structure, is the same. This is shown by the schematically drawn angle “XX°” in FIG. 5. This structural measure therefore allows a flexible adaptability of the headrest fixing means to various installation situations and different seat models or motor vehicle models.

1. A device for fixing a headrest to a seat of a vehicle, wherein the headrest has at least one retaining rod, the device comprising:
a receiving sleeve configured to receive the retaining rod; and
a connecting element configured to fix the receiving sleeve to the seat, and
wherein the receiving sleeve has a connecting section, which is connected to the connecting element,
wherein a connecting section of the receiving sleeve and the connecting element in the region in which the connecting section makes contact with the connecting element are designed in such a manner that when the connecting element is displaced along the connecting section the angle of the connecting element with respect to the receiving sleeve changes.

2. The device according to claim 1, wherein the connecting section has a contact face for the connecting element with an outwardly curved, convex shape.

3. The device according to claim 1, wherein the connecting section is essentially rectangular in its basic shape.

4. The device according to claim 1, wherein the connecting section exits out of the receiving sleeve and ends laterally in flat side regions.

5. The device according to claim 1, wherein the connecting element has a rounded portion, which corresponds with the connecting section.

6. The device according to claim 1, wherein the connecting element has a wide, central contact region, on which the connection to the receiving sleeve takes place.

7. The device according to claim 6, wherein the connecting element has two outer regions, which adjoin the contact region and are arranged approximately parallel to the plane of the contact region.

8. The device according to claim 6, wherein the contact region of the connecting element, which is used for the connection to the receiving sleeve is curved, and corresponds to the curvature of the connecting section of the receiving sleeve.

9. The device according to claim 1, wherein the connecting element is shorter in its vertical extent than the connecting section on the receiving sleeve.

10. A vehicle seat for a vehicle, wherein the vehicle seat has a device for fixing a headrest according to claim 1.
